(19) United States
(12) Patent Application Publication
(10) Pub. No.: US 2006/0083920 A1
(43) Pub. Date: Apr. 20, 2006

(54) External structure fire protection system "ESFPS"

(76) Inventors: Jens Schnabel, Torrance, CA (US); Peter Lust JR., Camarillo, CA (US)

Correspondence Address: AMEBA INVENTIONS, 300 ESPLANADE DR, SUITE 900, OXNARD, CA, 93036, US

(21) Appl. No.: 11/145,338

(22) Filed: Jun. 2, 2005

Related U.S. Application Data
(60) Provisional application No. 60/619,017, filed on Oct. 14, 2004.

(51) Int. Cl. F16J 15/20

(52) U.S. Cl. 428/365; 428/920

(57) ABSTRACT

A design for protection and resistance from externally started fires, forest fires and other fires that effect and start a structure burning from the outside inward. Protecting the entire structure with a specifically designed track system mounted onto the top of the structure, utilizing fire protective material hanging down the sides of the structure to create a fire resistant enclosure. “ESFPS” is designed to be assembled and set up in advance on the structure in preparation of a fire. The design allows for ease and quickness with installation. Pre-installation of the ESFPA on the roof of the structure that is being fire protected is required. This is achieved by reviewing the structure dimensions and then completing an assembly in advance. Sectional pieces are delivered to the structure then installed in advance. “ESFPS” is designed to be different lengths and are adapted to the unique dimensions of the structure.

### BACKGROUND OF INVENTION

Living in Southern California and seeing all the houses burning down, Ameba Inventions believes that a personally controlled system needs to be developed to reduce loss of home and private property and assist in control of insurance rates by offering lower risk to a structure owner in high fire areas.

### DESCRIPTION OF ART

The various figures supplied FIG. 1-3 show the aspects of the design and structure.

### SUMMARY OF INVENTION

In Summary the ESFPS will help saves property, lives and private possessions by protecting the structure from fire at the structures most vulnerable stage

### BRIEF DESCRIPTION OF DRAWINGS

FIG. 1 Assembly drawing of “ESFPS”

FIG. 2 Detailed parts drawings

FIG. 3 Magnetic/Fabric Connection

### DESCRIPTION OF OPERATION

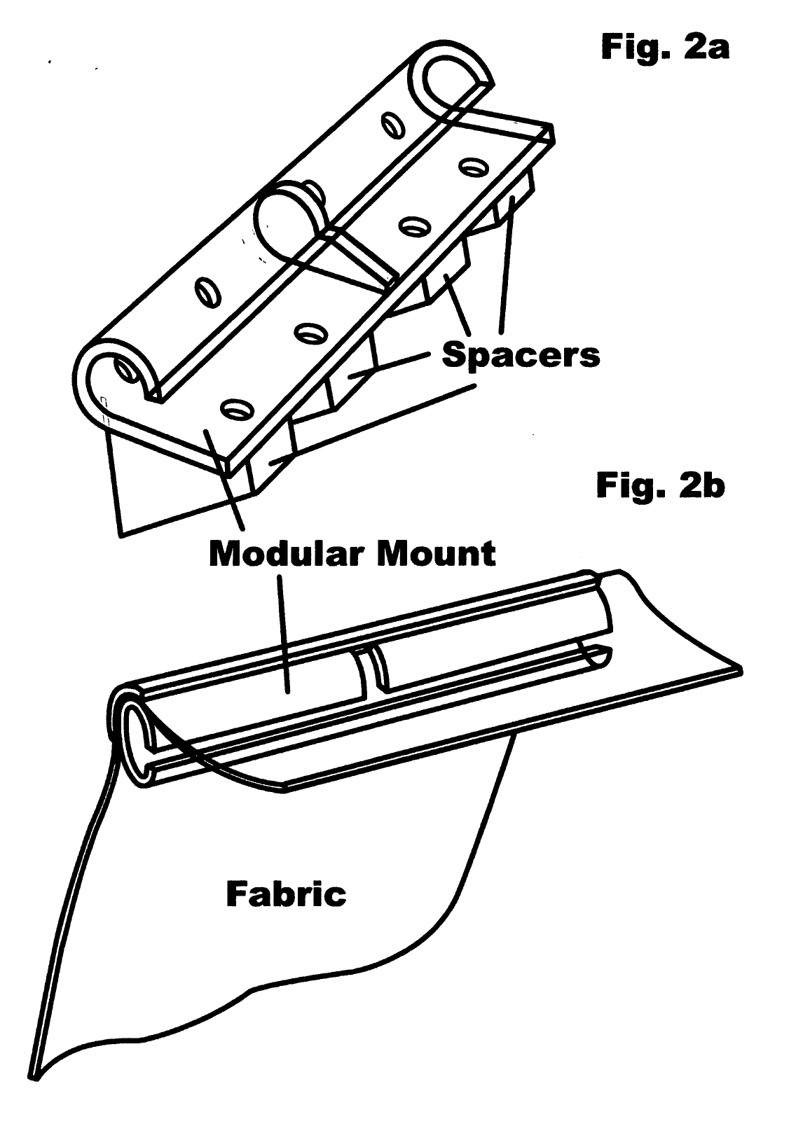

The Operation is achieved by protection and resistance from externally started fires, forest fires and other fires that effect and start a structure burning from the outside. Protecting the entire structure or house with specifically designed track system mounted onto the structure or house itself and utilizing fire protective material hanging down the sides of the structure. The “ESFPS” is designed to set up in advance on the structure in preparation of a fire on its way. Pre-installation of the mounting system on the top/roof of the structure that is being fire protected is required. This is achieved by initially reviewing the structure dimensions and then completing an assembly drawing in advance. The sectional materials are then delivered to the customer who in turn installs the “MODULAR MOUNTING SYSTEM” on the structure in advance. The “ESFPS” is designed as complete mounting system on the structure itself. It utilizes a specially designed molded, shaped and machined fixture system (FIG. 2a,b).

The second major area of the “ESFPS” is in the uniquely designed and modular fire resistant sections, made of fabric that is capable of resisting an extremely high temperature. These sections are rolled up for storage and stored in a long-term safe keeping storage container to allow for use with many years between.

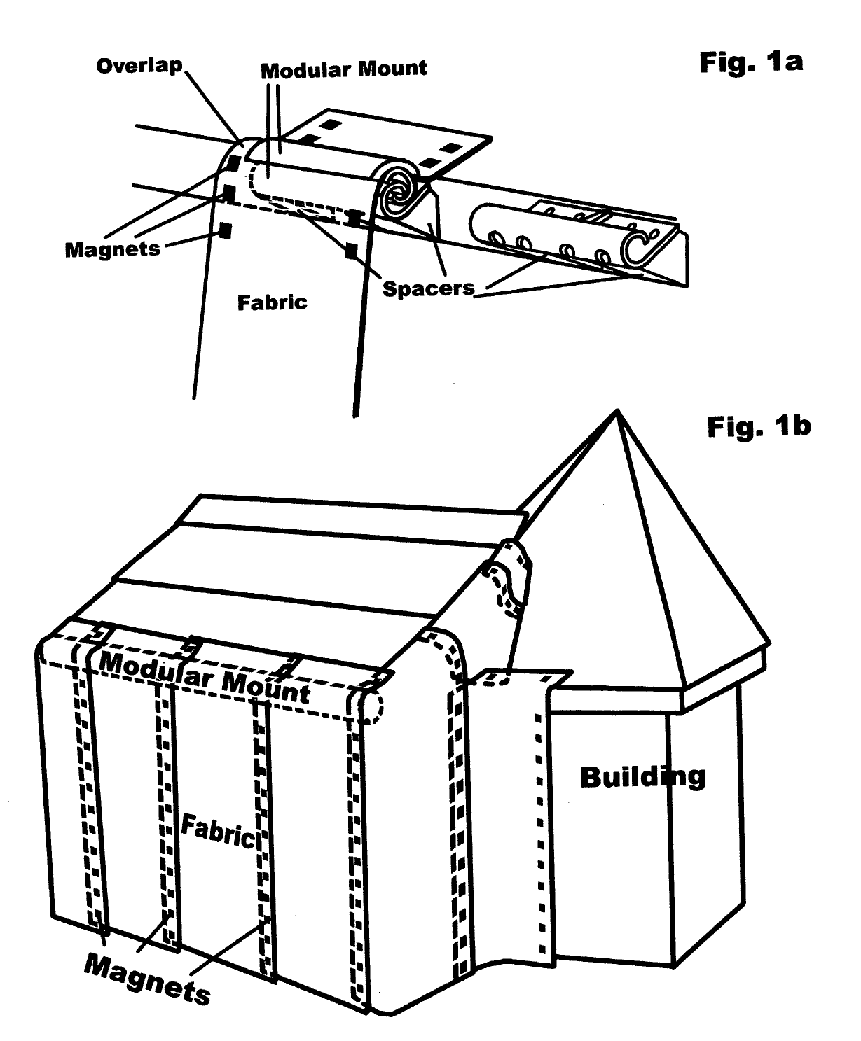

When unwrapped the fire resistant fabric and internally designed holding fixtures with its fire resistant material are attached to the “MODULAR MOUNT” on the roof of the structure and then hang down the side of the structure. (FIGURE 1a,b) The “ESFPS” utilizes a secondary option mechanism of existing technology water sprinkler systems but attached in a unique way that compliments the fire protection ability of the “ESFPS”. The materials used in the sprinkler system are also made and molded from high temperature composite and ceramic materials to insure that no melting can occur.

Interlocking Connections

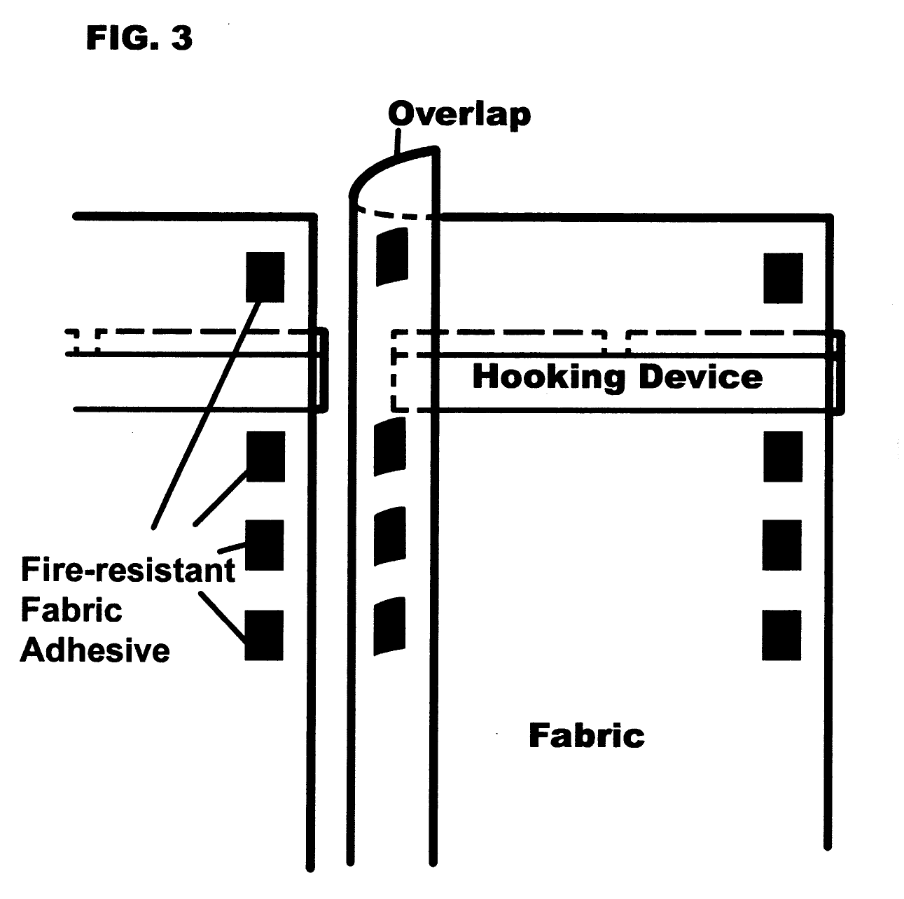

The “ESFPS” utilizes a mechanism (FIG. 3) for attaching each section of the systems together. This is achieved by utilizing high temperature fabric adhesive material sewn into the fireproof fabric for attachment of different sections. The locations of the high temperature fabric adhesive are specifically decided in advance of the assembly of the overall “ESFPS”.

Installation

The “ESFPS” operates independently once installed. The pre-installation of the tracks, which are mounted on the edge of the roof of the structure, which could be a house, home or building. The design allows for use with any reasonable size structure by being specially made to the specifications and dimensions of the structure it will protect. “ESFPS” claims uniqueness of concept and ornamental design of combining all the elements that in total achieve a mechanical design that allows for significant fire protection. The fire protection is achieved by a combination of fire protection material hanging down the sides of the structure and can be augmented with option external sprinkler systems pre-mounted on the roof parameter of the structure.

“Modular Mount”

The “MODULAR MOUNT” is constructed of sections in (example 4, 5 and 6 feet standard lengths. (FIG. 2a, b) The design of the mount is considered unique and molded from fire resistant composite style materials as well as machined metal such as aluminum allow or steel for the purpose of hanging the fire prevention material. The design of the “MODULAR MOUNT” is such that it is capable of carrying a minimum of 3 times its weight in strength. The internal construction of the “MODULAR MOUNT” utilizes a composite/ceramic and/or aluminum alloy/metal molded hanging feature as and claimed in this patent (FIG. 2b).

Anti Slip

An “ANTI-SLIP” feature that allows the overall “ESFPS” to hang in most any angles whilst maximizing the area protected by the fire resistant fibers are also claimed in this patent. The “MODULAR MOUNT” consists of 2 separated molded units that have a “HOOK AND HOLD” system, which prevents the “MODULAR MOUNT” from moving. (FIG. 2).

Compensation for Gaps and Different Levels of Roofs

Spacers are used under “MODULAR MOUNT” to allow for the “MODULAR MOUNT” to be in a parallel position on the roof of the structure.

Fiber Embedded in Modular Mount:

One part of the MODULAR MOUNT (FIG. 2a) embeds the fire-resistant fabric to fix it to its needed position.

“Hanging Mechanism”

The “HANGING MECHANISM” (FIG. 2b) is a molded mounting fixture that is easy to install and made from the same high strength/high temperature material that the “MODULAR MOUNT” is made from. The anchoring function of the HANGING MECHNISM is claimed in this patent as a specifically designed and uniquely designed mechanism that has been fabricated in a modular fashion for the specific purpose of being able to hang the fire proof material.

The “HANGING MECHANISM” and the “MODULAR MOUNT” are both molded from a liquid or molten metal liquid. The materials used to achieve the final product are made from high temperature materials that WILL NOT BURN below 800° C. (Celsius) and 2000° F. (Fahrenheit) for the specific materials. The material used will not burn due to the fact that fire burns at a relative worst case approximately 1600 deg. F. The materials used in this design allow for a safety margin.

Antislip Mechanism

Designed and manufactured with the “MODULAR MOUNT” is a specifically designed ANTISLIP

References

The “ESFPS” does not infringe on any other patents as a complete concept and design, it utilizes much of existing materials.

Examples of Some Materials Used but Limited to

3M 312-fiberglass fireproof cloth material

Aremco Composite materials

Standard Aluminum and cast aluminum

Standard Steel type materials

### DESCRIPTION OF RELATED ART

FIG. 1a,b Completed Assembly drawing

FIGS. 2a,b Detailed Assembly Drawing

FIG. 3 Fire resistant fabric adhesive Connection

1. Protects the external of a structure from the element of fire utilizing a hanging mechanism approach with high temperature materials used of up to 800° C. (Celsius) and 2000° F. (Fahrenheit). The “ESFPS” is rated for a period of 15 minutes none stop.

2. Provides flexibility to fit nearly any structure and any shape and utilizes a specifically designed “MODULAR MOUNT” connection system on the roof of the structure that is fire resistant to the levels stated in claim 1. The “MODULAR MOUNT” is claimed as a unique element of the “ESFPS” design. The “MODULAR MOUNT” consists of 2 separated molded units that have a “HOOK AND HOLD” (claim 3) system integrally designed into the “MODULAR MOUNT”, which ensures that the “MODULAR MOUNT” does not move. (FIG. 2).

3. The “HOOK AND HOLD” feature in the “MODULAR MOUNT” is claimed as a unique feature of “ESFPS” design. The “HOOK AND HOLD” allows for the holding of the fire-resistant material.

4. Utilizes a “High Temperature fabric adhesive” sewn into the fireproof fabric in a specific arrangement that acts as a secondary locking mechanism for section to section for connection (FIG. 3)

5. The design offers the advantage of being able to be pre-manufactured and stored for use when a fire emergency presents itself. The “ESFPS” systems is designed to be installed on short notice (FIG. 1)

6. The “ESFPS” is a modular design that is made in 4-6 foot lengths and can be utilized on any size structure simply be adding sections or reducing sections. The modular design allows for going around corners and none straight areas by utilizing a mounting mechanism that is sectional therefore flexible. (FIG. 2)

7. Utilizes fireproof material to hang down the side of a structure that can be any shape or size which is attached to the “MODULAR MOUNT”.

8. Utilizes a secondary sprinkler type extinguishing water systems that works in conjunction with and assists in the cooling of the fire protection system.

9. Utilizing user-friendly packaging in that the system can be designed and modified to fit any structure

10. The “ESFPS” utilizes a uniquely designed ANTISLIP Mechanism that allows for the use of the “ESFPS” on angles of different styled roofs

11. The “HANGING MECHANISM” embeds the fiber material and is a molded mounting fixture that is easy to install and made from the same high strength/high temperature material that the “MODULAR MOUNT” is made from. The anchoring function of the ““HANGING MECHANISM”” is claimed in this patent as a specifically designed and uniquely designed mechanism that has been fabricated in a modular fashion for the specific purpose of being able to hang the fire resistant material. The “HANGING MECHANISM” is a molded mounting fixture that is easy to install and made from the same high strength/high temperature material that the “MODULAR MOUNT” is made from. The anchoring function of the “HANGING MECHNISM” is claimed in this patent as a specifically designed and uniquely designed mechanism that has been fabricated in a modular fashion for the specific purpose of being able to hang the fire resistant material.

12. COMPENSATION FOR GAPS AND DIFFERENT LEVELS of ROOFS Spacers are used under the “MODULAR MOUNT” to allow for the “MODULAR MOUNT” to be in a parallel position on the roof of the structure. This feature is called the “COMPENSATION FOR GAPS”
